(19) United States
(12) Patent Application Publication
(10) Pub. No.: US 2014/0108940 A1
(43) Pub. Date: Apr. 17, 2014

(54) METHOD AND SYSTEM OF REMOTE COMMUNICATION OVER A NETWORK

(71) Applicants: Dwight Diercks, Saratoga, CA (US); Franck Diard, Mountain View, CA (US)

(72) Inventors: Dwight Diercks, Saratoga, CA (US); Franck Diard, Mountain View, CA (US)

(73) Assignee: NVIDIA CORPORATION, Santa Clara, CA (US)

(21) Appl. No.: 13/652,320

(22) Filed: Oct. 15, 2012

(51) Int. Cl. G06F 3/048

(52) U.S. Cl. 715/738

(57) ABSTRACT

A system and method for communicating over a network are presented. Embodiments of the present invention are operable to capture a touch input directly from an electronic visual display coupled to a client device. The touch inputs are then transmitted from the client device to a host device over a network. The host device proceeds to render data in response to the touch input provided by the client device, which is then transmitted back to the client device over the network for display on the client device.

### FIELD OF THE INVENTION

Embodiments of the present invention are generally related to the field of devices capable of communicating with a host device from a remote location.

### BACKGROUND OF THE INVENTION

Conventional remote desktop technology enables a user to remotely access a host computer using another computer that is connected to the same network as the host computer. This technology allows a user to use an application that is located on the host computer without having physical access to the host. Providing this level of access is desirable given the great deal of flexibility that is afforded by this technology in terms of financial and computational costs. Remote desktop technology allows multiple users to access a single application or multiple applications that reside on a single host computer, rather than requiring multiple users to each individually purchase and install separate copies of the same applications on to their local computers. Furthermore, by installing applications on the host computer and providing access to these applications to other remote computers within the same network, computer memory may be conserved within these remote computers as they do not require these shared applications to be installed locally.

However, the rising number of applications utilizing touch screen technology has exposed some of the limitations of conventional remote desktop technology. These limitations are further appreciated when using mobile devices, such as tablet computers, which primarily rely touch screen interfaces for receiving user input. Ironically, in most network schemes in which the host computer is configured as a server used to host touch screen-adapted applications, the host computers themselves are rarely equipped with touch screen technology and, thus, rely on traditional forms of input device, such as a mouse and/or keyboard to provide user input.

Furthermore, installing memory intensive applications that utilize touch screen technology on a mobile device, which are traditionally designed with little memory and limited battery life, may result in slow computational times and wasted battery life on the mobile device. Furthermore, these inefficiencies may lead to a user being frustrated at not being able to enjoy the touch screen capabilities of his or her mobile device when using applications that are designed specifically for touch screen use.

### SUMMARY OF THE INVENTION

Accordingly, a need exists to address the inefficiencies discussed above. Embodiments of the present invention provide a novel solution to allow users to enjoy the touch screen features of their device as well as applications designed specifically for those with touch screen devices. Embodiments of the present invention are operable to capture a touch input directly from an electronic visual display coupled to a client device (e.g., a mobile phone, tablet device, laptop device, or the like). The touch inputs are then transmitted from the client device to a host device (e.g., a server, mainframe computer, desktop personal computer, or the like) over a network (e.g., including wired and/or wireless communication and including the Internet). The host device proceeds to render data in response to the touch input provided by the client device, which is then transmitted back to the client device over the network for display on the client device.

More specifically, in one embodiment, the present invention is implemented as a method of remote network communication. The method includes capturing a touch input directly from an electronic visual display coupled to a client device. The method also includes transmitting the touch input from the client device to a host device over a network. The method of transmitting further includes packetizing the touch input using the client device. In one embodiment, the touch input is packetized using H.264 format.

Additionally, the method includes rendering a display in response to the touch input using the host device producing a rendered data as well as displaying the rendered data on the client device. The method of rendering further includes packetizing the rendered data. The method of displaying further includes receiving the rendered data from the host device over the network. In one embodiment, the client device is operable to execute a respective application independent of any other client device from a plurality of client devices. In one embodiment, the host device is a virtual machine, in which the virtual machine is operable to execute a respective application independent of any other virtual machine from a plurality of virtual machines.

In another embodiment, the present invention is implemented as a system for remote network communication. The system includes a client device coupled to an electronic visual display in which the electronic visual display is operable to capture touch input, in which the client device is operable to transmit the touch input over a network, in which the client device is further operable to display a rendered data. In one embodiment, the client device is further operable to packetize the touch input. In one embodiment, the client device is operable to execute a respective application independent of any other client device from a plurality of client devices.

The system also includes a host device operable to render a display in response to the touch input to produce the rendered data, in which the host device is operable to transmit the touch input over the network. In one embodiment the host device is further operable to packetize the rendered data. In one embodiment, the client device is further operable to receive the rendered data from the host device over the network. In one embodiment, the touch input is packetized using H.264 format. In one embodiment, the host device is a virtual machine, in which the virtual machine is operable to execute a respective application independent of any other virtual machine from a plurality of virtual machines.

In yet another embodiment, the present invention is implemented as a non-transitory computer readable medium for remote network communication. The computer readable medium includes capturing a touch input directly from an electronic visual display coupled to a client device. The computer readable medium also includes transmitting the touch input from the client device to a host device over a network. The computer readable medium of transmitting further includes packetizing the touch input using the client device. In one embodiment, the touch input is packetized using H.264 format.

Additionally, the computer readable medium includes receiving a rendered display in response to the touch input from the host device producing a rendered data as well as displaying the rendered data on the client device. The computer readable medium of receiving the rendered display further includes unpacketizing the rendered data. The computer readable medium of displaying further includes rendering the rendered data from the host device. In one embodiment, the client device is operable to execute a respective application independent of any other client device from a plurality of client devices. In one embodiment, the host device is a virtual machine, in which the virtual machine is operable to execute a respective application independent of any other virtual machine from a plurality of virtual machines.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 provides an illustration of the flow of data between a client device and a host device in accordance to embodiments of the present invention.

FIG. 2 is a flowchart of an exemplary method for transmitting user touch events over a network in an embodiment according to the present invention.

FIG. 3A is a block diagram of an example of a host device capable of implementing embodiments according to the present invention.

FIG. 3B is a block diagram of an example of a client device capable of implementing embodiments according to the present invention.

FIG. 4A provides another illustration of the flow of data between a client device and a host device in accordance to embodiments of the present invention.

FIG. 4B provides another illustration of the flow of data between a client device and a host device in accordance to embodiments of the present invention.

FIG. 4C provides yet another illustration of the flow of data between a client device and a host device in accordance to embodiments of the present invention.

FIG. 5 is a block diagram of a system capable of implementing embodiments according to the present invention.

FIG. 6 is another block diagram of a system capable of implementing embodiments according to the present invention.

FIG. 7 is a flowchart of an exemplary method for transmitting user touch events over a network in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

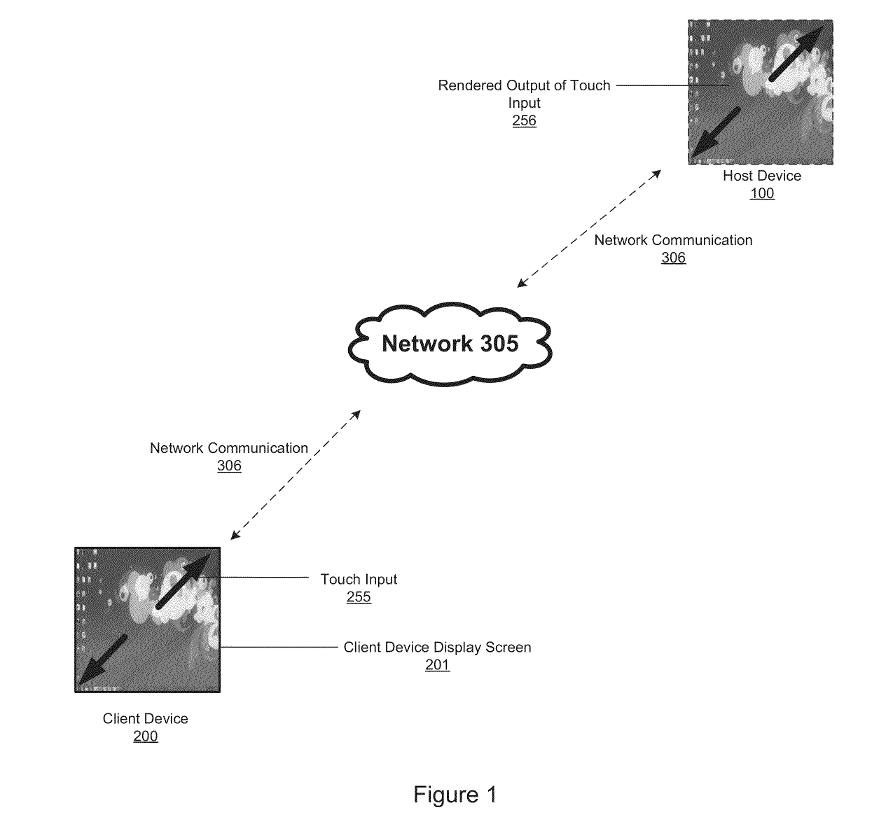

Portions of the detailed description that follow are presented and discussed in terms of a process. Although operations and sequencing thereof are disclosed in a figure herein (e.g., FIG. 1) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an object, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

FIG. 1 provides an exemplary network communication between host device 100 and client device 200 in accordance with embodiments of the present invention. In one embodiment, touch input 255 is captured directly from client device display screen 201, which is coupled to client device 200. Touch input 255 is then transmitted from client device 200 to host device 100 over network 305 through network communication 306 via data packets. Network communication 306 may be a network socket created within network 305 which enables both host device 100 and client device 200 to receive and transmit data packets over network 305. Upon receipt of the data packets through network communication 306, host device 100 proceeds to render data in response to the touch input 255 provided by the client device 200, which produces rendered output 256. Rendered output 256 is then packetized and transmitted back to client device 200 over network 305, through network communication 306, which is then displayed on client device display screen 201. Embodiments of the present invention support network configurations in which a host device, e.g. host device 100, is not coupled to a display screen (depicted as dashed lines along the perimeter of host device 100 in FIG. 1), but is still operable to render output in the form of rendered output 256.

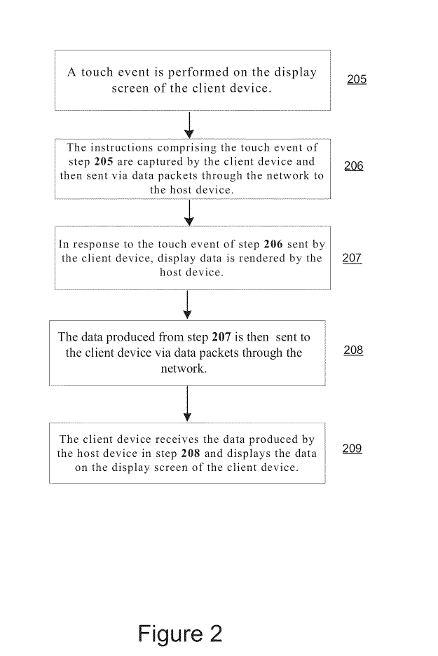

FIG. 2 presents a flow chart which describes exemplary steps in accordance with the various embodiments herein described.

At step 205, a touch event is performed on the display screen of the client device.

At step 206, the instructions comprising touch event of step 205 are captured by the client device and then sent via data packets to the host device through the network.

At step 207, in response to the touch event of step 210 sent by the client device, display data is rendered by the host device.

At step 208, the data produced from step 215 is sent to the client device via data packets over the network.

At step 209, the client device receives the data packets sent by the host device and proceeds to display the data.

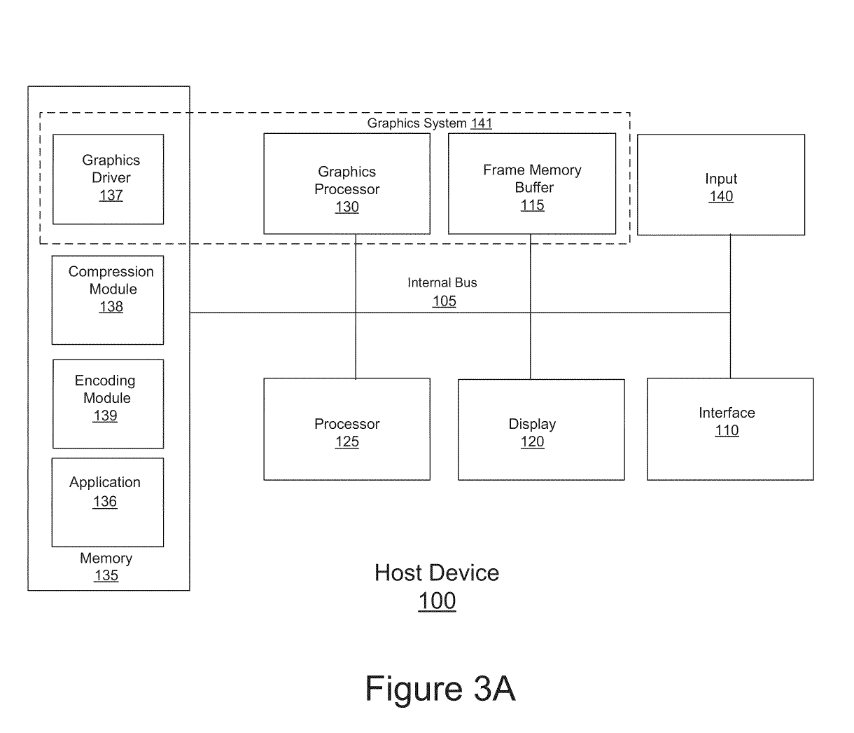

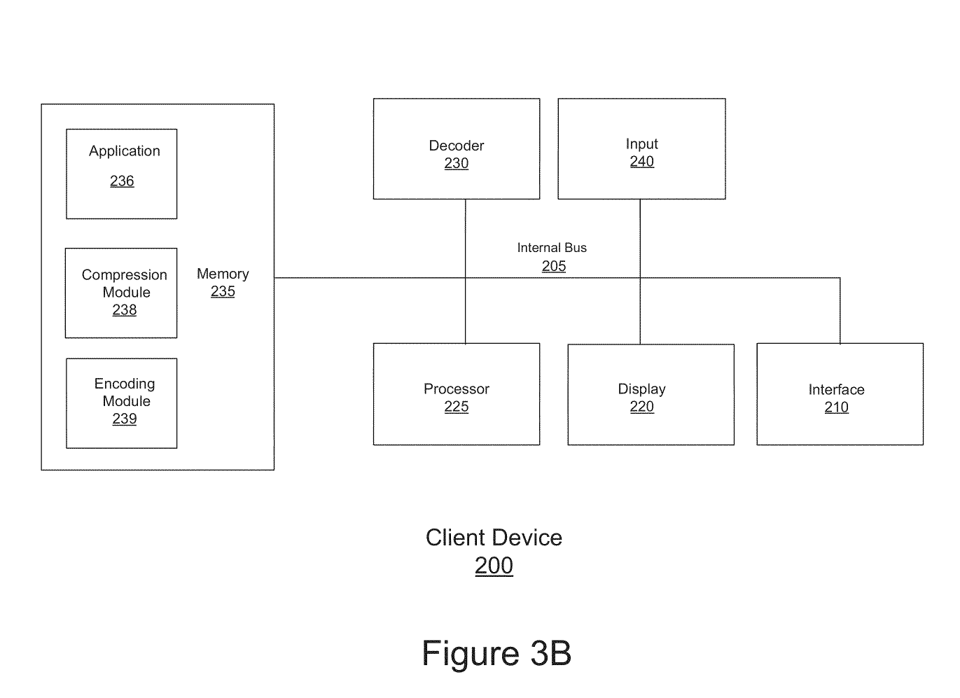

As presented in FIG. 3A, an exemplary host device 100 upon which embodiments of the present invention may be implemented is depicted. Furthermore, exemplary host device 100 may be implemented as server, laptop, desktop computer, or the like, as contemplated by embodiments of the present invention. In one embodiment of the present invention, may utilize host device 100 as a centralized server device or data center.

Host device 100 includes processor 125 which processes instructions from application 136 located in memory 135 to read data received from interface 110 and to store the data in frame memory buffer 115 for further processing via internal bus 105. Optionally, processor 125 may also execute instructions from an operating system located in memory 135. Optional input 140 includes devices that communicate user inputs from one or more users to host device 100 and may include keyboards, mice, joysticks, touch screens, and/or microphones. In one embodiment of the present invention, application 136 represents a set of instructions that are capable of using user inputs such as touch screen input, in addition to peripheral devices such as keyboards, mice, joysticks, touch screens, and/or microphones, or the like.

Interface 110 allows host device 100 to communicate with other computer systems via an electronic communications network, including wired and/or wireless communication and including the Internet. The optional display device 120 is any device capable of rendering visual information in response to a signal from host device 100.

Graphics system 140 comprises graphics driver 137, graphics processor 130 and frame memory buffer 115. Graphics driver 137 is operable to assist graphics system 141 in generating a stream of rendered data to be delivered to a client device by providing configuration instructions.

Graphics processor 130 may process instructions from application 136 to read data that is stored in frame memory buffer 135 and to send data to processor 125 via internal bus 175 for rendering the data on display device 120. Graphics processor 130 generates pixel data for output images from rendering commands and may be configured as multiple virtual graphic processors that are used in parallel (concurrently) by a number of applications, such as application 136, executing in parallel.

Frame memory buffer 115 may be used for storing pixel data for each pixel of an output image. In another embodiment, frame memory buffer 115 and/or other memory may be part of memory 135 which may be shared with processor 125 and/or graphics processor 130. Additionally, in another embodiment, host device 100 may include additional physical graphics processors, each configured similarly to graphics processor 130. These additional graphics processors may be configured to operate in parallel with graphics processor 130 to simultaneously generate pixel data for different portions of an output image, or to simultaneously generate pixel data for different output images.

Compression module 138 is operable to compress the input received via interface 110 using convention methods of data compression. Compression module 138 may also be operable to uncompress compressed input received via interface 110 using conventional methods as well. Encoding module 139 is operable to encode rendered data produced by graphics system 141 into conventional formats using conventional methods of encoding data. Also, encoding module 139 may also be operable to decode input received via interface 110 using conventional methods. In one embodiment of the present invention, compression module 138 and encoding module 139 may be implemented within a single application, such as application 136, or reside separately, in separate applications.

FIG. 3B provides an exemplary client device upon which embodiments of the present invention may be implemented is depicted. Client device 200 may be implemented as a remote device which may communicate with other host computer systems (i.e., host device 100 of FIG. 3A). Furthermore, client device 200 may be any type of device that has display capability, the capability to decode (decompress) data, and the capability to receive inputs from a user and send such inputs to a host computer, such as host device 100. Client device 200 may be a mobile device with a touch screen interface that is operable to send control information (e.g., user inputs) to host device 100 over the network 305. Furthermore, network 305 may be a wireless network, a wired network, or a combination thereof.

Client device 200 includes a processor 225 for running software applications and optionally an operating system. Input 240 is operable to communicate user inputs from one or more users through the use of keyboards, mice, joysticks, and/or microphones, or the like. Interface 210 allows client device 200 to communicate with other computer systems (e.g., host device 100 of FIG. 3A) via an electronic communications network, including wired and/or wireless communication and including the Internet.

Decoder 230 is any device capable of decoding (decompressing) data that is encoded (compressed). In one embodiment of the present invention, decoder 255 may be an H.264 decoder. The display device 220 is any device capable of rendering visual information, including information received from the decoder 255. Display device 220 is used to display visual information received from host device 100. Furthermore, display device 220 is further operable to detect user commands executed via touch screen technology or similar technology. The components of the client device 200 are connected via one or more internal bus 205.

Compression module 238 is operable to compress the input received via interface 210 using convention methods of data compression. Compression module 238 may also be operable to uncompress compressed input received via interface 110 using conventional methods as well. Encoding module 239 is operable to encode the input received via interface 210 into conventional formats using conventional methods of encoding data. In one embodiment of the present invention, decoder 230 and encoding module 239 may be implemented as one module. Also, in one embodiment of the present invention, compression module 238 and encoding module 239 may be implemented within a single application, such as application 236, or reside separately, in separate applications.

Relative to the host device 100, client device 200 has fewer components and less functionality and, as such, may be referred to as a thin client. In one embodiment of the present invention, application 236 represents a set of instructions that are capable of capturing user inputs such as touch screen input. However, the client device 200 may include other components including those described above. Client device 200 may also have additional capabilities beyond those discussed above.

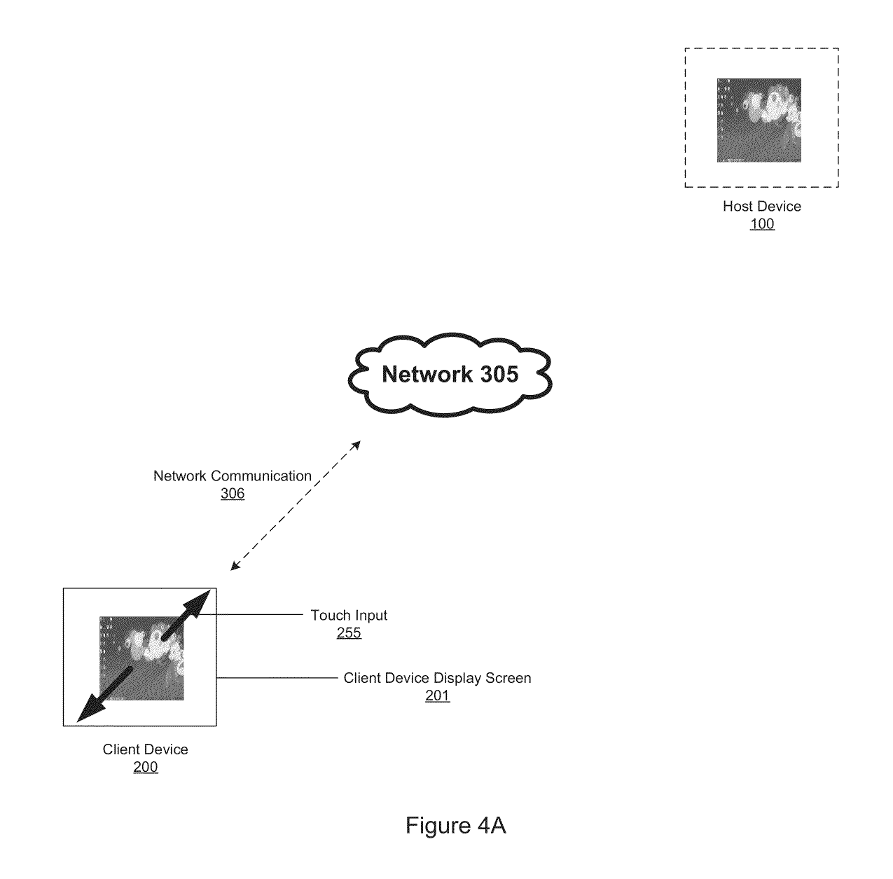

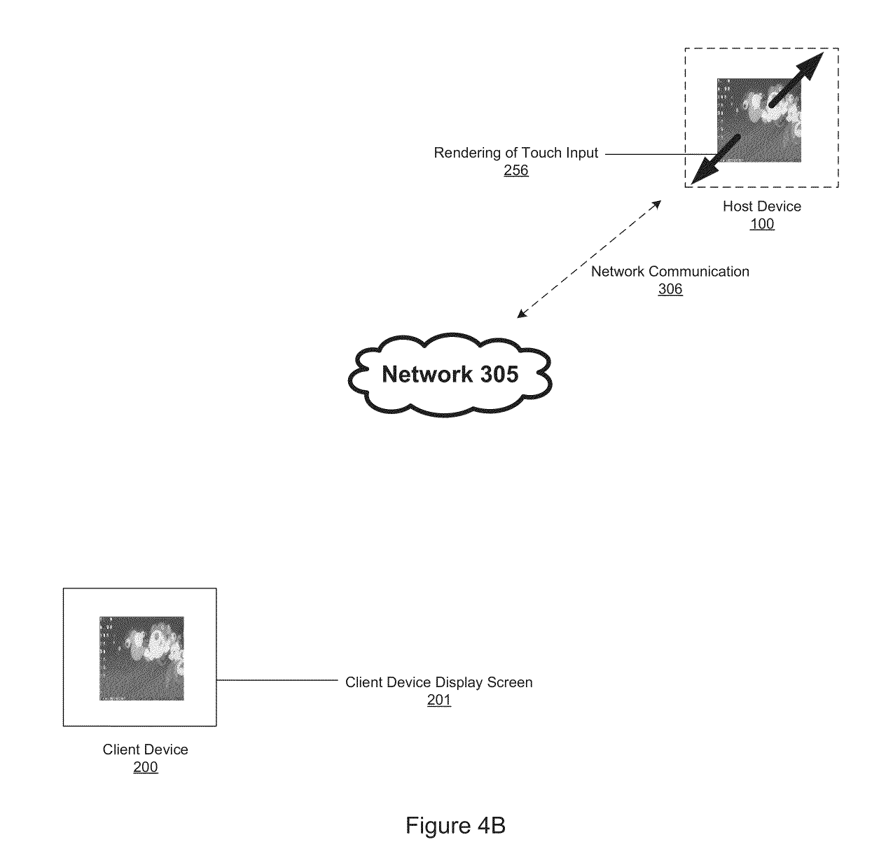

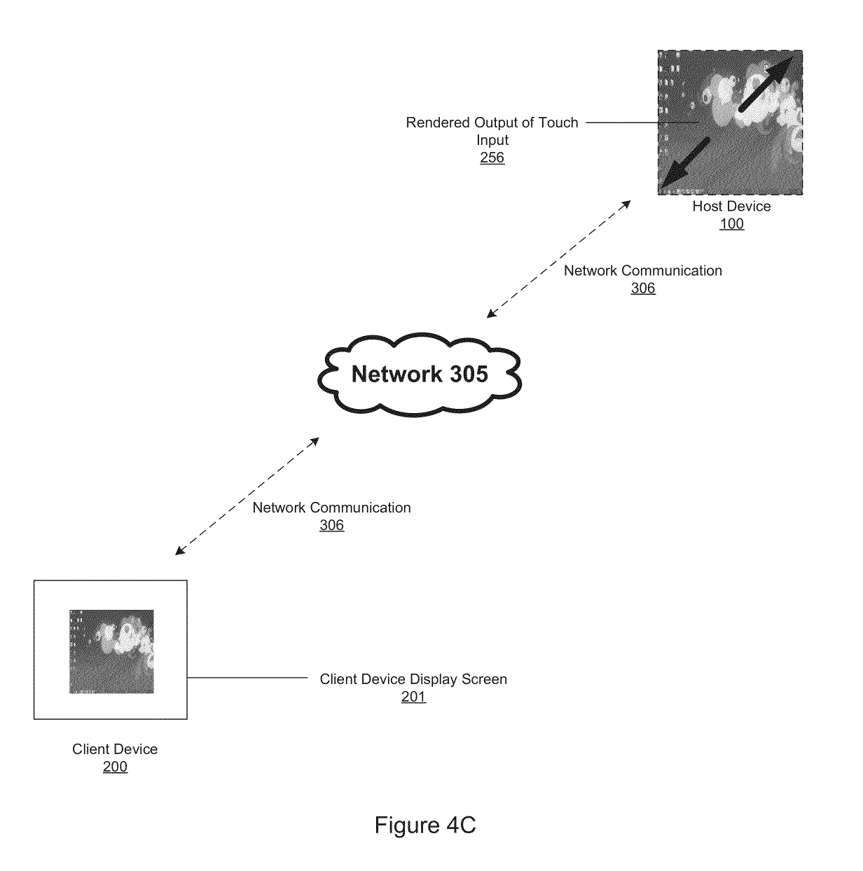

FIG. 4A presents another exemplary depiction of how a user using client device 200 may send control information in the form of touch input 255 over network 305 to host device 100 in accordance with embodiments of the present invention. As illustrated in FIG. 4A, a user may choose to issue a “spread” command in which the user's fingers touch the surface of the display screen with two fingers and move them apart. Touch input 255 may also be in the form of other common touch screen commands, such as a “pinch” command used to shrink the size of an image or a “tap” command used to open a file or execute a program located on the display screen, or similar commands.

As the user performs touch input 255 on client device 200, the instructions comprising touch input 255 are captured, compressed and then sent via data packets through a network communication 306 created within network 305, where host device 100 receives the packet and then proceeds to uncompress and decode it. In one embodiment of the present invention, host device 100 may be operable to listen to a specified socket in order to detect events transmitted by client device 200.

Client 200 may utilize conventional techniques used to couple client device 200 to an electronic communications network, such as network 305, including wired and/or wireless communication as well as the Internet. Furthermore, client 200 may utilize conventional compression techniques to compress the instructions comprising touch input 255 as well as conventional network delivery techniques to deliver the packet to host device 100 through the creation of network communication 306 created within network 305.

As illustrated in FIG. 4B, host device 100 uncompresses the data packets received via network communication 306 and begins rendering the pixels of the output image associated with the “spread” command attributed to touch input 255. In one embodiment of the present invention, host device 100 may be operable to listen to a specified socket in order to detect multiple touch inputs transmitted by client device 200 while processing the data packets received.

As illustrated in FIG. 4C, with reference to FIG. 3A, host device 100 grabs the rendered output and then produces video packets which are then compressed by the graphics system 141 of host 100 and then sent to client 200 via data packets through network communication 306 created within network 305. Data packets contain the pixel data processed by graphics system 141 which is used to generate pixel data for rending the output images. In one embodiment, data packets may contain pixel data processed by multiple graphics processors 130 within graphics system 141 which may be used to render the same output data or render output data that is different from one another. Client device 200 receives the data packets through network communication 306 created in network 305 and proceeds to uncompresses data packet 251. Client device 200 then begins to render the output image associated with the “spread” command attributed to touch event command 255, which is then displayed for the user via client device display screen 201 (See FIG. 1).

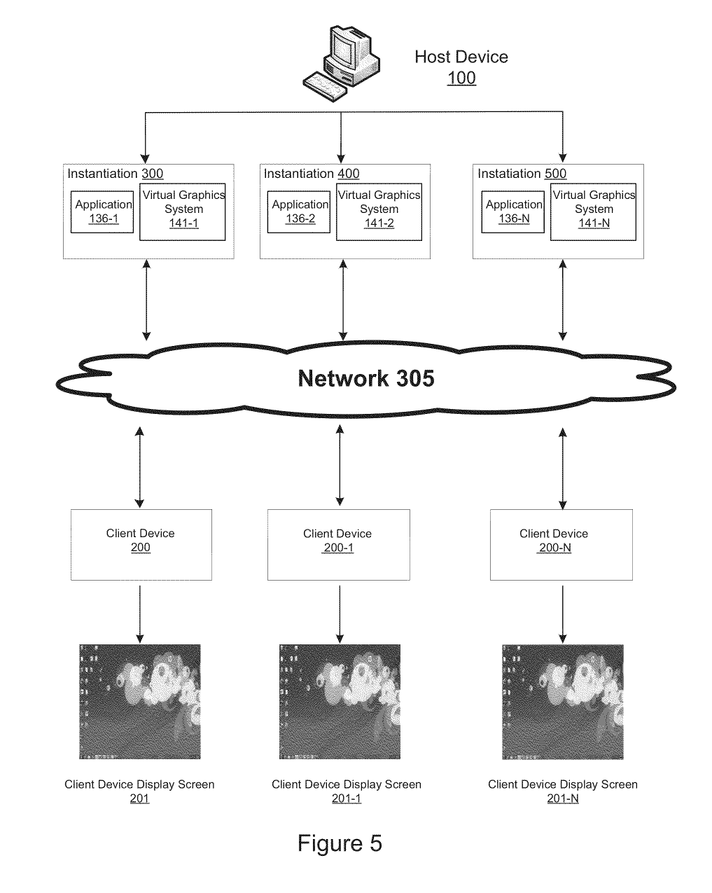

FIG. 5 provides another exemplary network communication involving host device 100 and a plurality of client devices similar to client device 200 in accordance with embodiments of the present invention. Host device 100 may be communicatively coupled to a number of client devices over a given network, such as client devices 200 through 200-N over network 305. Client devices 200 through 200-N are depicted in FIG. 5 as remote devices that are independent of host device 100.

The multi-threaded nature of the embodiments of the present invention allow for the multi-threaded execution of an application residing in a host device. In one embodiment, with reference to FIG. 3A, application 136 residing in memory 135 of host device 100 may be executed by client devices 200 through 200-N with each device having their own instantiation of application 136 (instantiation 300, instantiation 400 and instantiation 500, respectively illustrated in FIG. 5). As a result, displays 201 through 201-N are accessible to host device 100 only via the respective client device 200 through 200-N.

According to one embodiment of the present invention, client devices 200 through 200-N provide control information (e.g., user inputs) to host device 100 over network 305. Responsive to the control information, host device 100 executes application 136 to generate output data, which is transmitted to the client devices 200 through 200-N via the network 305, through each client device's respective instantiation. The output data of application 136 may be encoded (compressed) which is then decoded and uncompressed by client devices 200 through 200-N. Significantly, these client devices are stateless in the sense that application 136 is not installed on them. Rather, client devices 200 through 200-N rely on host device 100 to store and execute application 136.

Furthermore, in response to the inputs from the client devices 200 to 200-N, virtual graphics systems may be used by embodiments of the present invention to generate display data. The display data can be encoded using a common, widely used, and standardized scheme such as H.264.

According to one embodiment of the present invention, instantiation 300 comprises virtual graphics system 141-1 and application 136-1. Virtual graphics system 141-1 is utilized by the application 136-1 to generate display data (output data) related to application 136-1. The display data related to instantiation 300 is sent to client device 200 over network 305.

Similarly, instantiation 400 comprises virtual graphics system 141-2 and application 136-2. In parallel, in response to the inputs from the client device 200-1, virtual graphics system 141-2 is utilized by application 136-2 of instantiation 400 to generate display data (output data) related to application 136-2. The display data related to instantiation 400 is sent to client device 200-1 over network 305.

Furthermore, instantiation 500 comprises virtual graphics system 141-N and application 136-N. In parallel, in response to the inputs from the client device 200-N, virtual graphics system 141-N is utilized by application 136-N of instantiation 500 to generate display data (output data) related to application 136-N. The display data related to instantiation 500 is sent to client device 200-N over network 305.

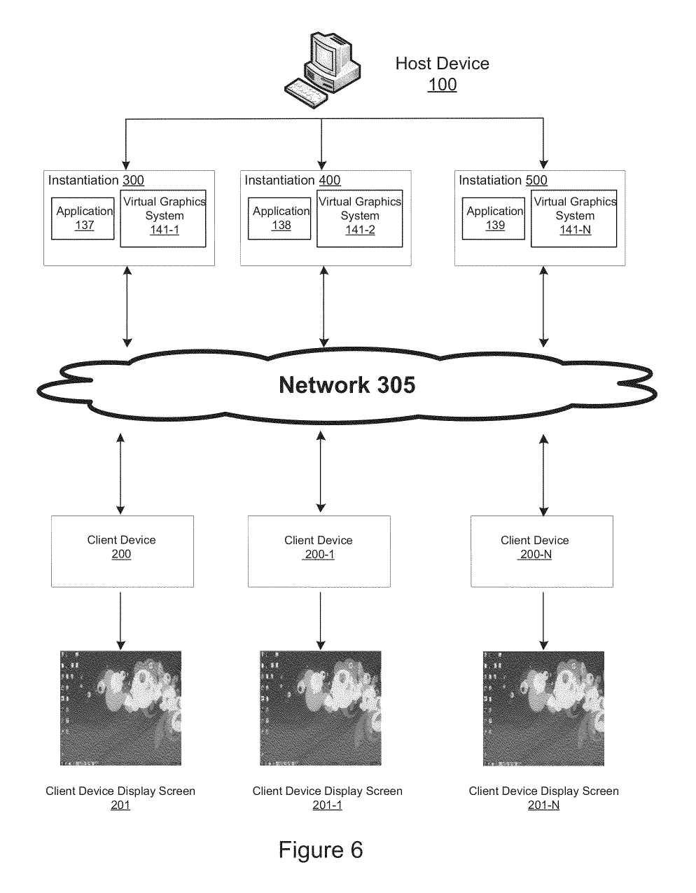

As illustrated in FIG. 6, alternatively, client devices 200 through 200-N may each receive different applications. In one embodiment, client device 200 provides control information for application 137 to the host device 100 over the network 305. In parallel, the client device 200-1 provides control information for application 138 to host device 100 over the network 305. Similarly, also in parallel, client devices 200-N provide control information for application 139 to host device 100 over the network 305.

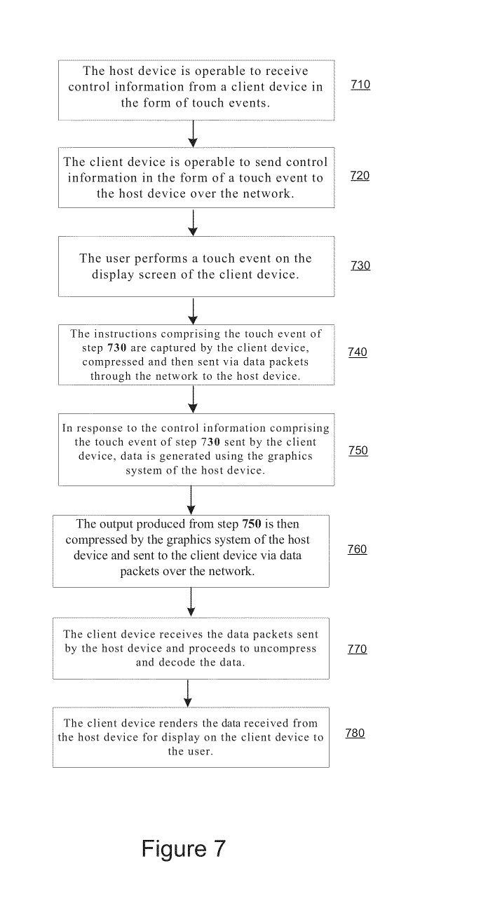

FIG. 7 is another flowchart which describes exemplary steps in accordance with the various embodiments herein described.

At step 710, the host device is operable to receive control information from a user in the form of touch events. The host device includes a graphics system which executes instructions from an application, stored in memory of the host device, which is responsive to control information in the form of touch events. The graphics system is operable to generate display data that may be displayed on a client device and is configured for concurrent use by multiple applications executing in parallel (e.g., virtual graphic processors).

At step 720, the client device is operable to send control information in the form of a touch event to the host device over the network. The network may be a wireless network, a wired network, or a combination thereof.

At step 730, the user performs a touch event on the display screen of the client device.

At step 740, the instructions comprising the touch event of step 730 are captured by the client device, compressed and then sent via data packets through the network to the host device.

At step 750, in response to the control information comprising the touch event of step 730 sent by the client device, data is generated using the graphics system of the host device.

At step 760, the output produced from step 750 is then compressed by the graphics system of the host device and sent to the client device via data packets over the network.

At step 770, the client device receives the communication packet sent by the host device and proceeds to uncompress and decode the data.

At step 780, the client device renders the data received from the host device for display on the client device to the user.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of remote network communication, comprising:
capturing a touch input directly from an electronic visual display coupled to a client device;
transmitting said touch input from said client device to a host device over a network;
rendering a display responsive to said touch input using said host device producing a rendered data; and
displaying said rendered data on said client device.

2. The method of remote network communication described in claim 1, wherein said transmitting further comprises:
packetizing said touch input using said client device.

3. The method of remote network communication described in claim 1, wherein said rendering further comprises:
packetizing said rendered data.

4. The method of remote network communication described in claim 1, wherein said displaying further comprises:
receiving said rendered data from said host device over said network.

5. The method of remote network communication described in claim 1, wherein said touch input is packetized using H.264 format.

6. The method of remote network communication described in claim 1, wherein said client device is operable to execute a respective application independent of any other client device from a plurality of client devices.

7. The method of remote network communication described in claim 1, wherein said host device is a virtual machine, wherein said virtual machine is operable to execute a respective application independent of any other virtual machine from a plurality of virtual machines.

8. A system for remote network communication, comprising:
a client device coupled to an electronic visual display wherein said electronic visual display is operable to capture touch input, wherein said client device is operable to transmit said touch input over a network, wherein further said client device is operable to display a rendered data; and
a host device operable to render a display responsive to said touch input to produce said rendered data, wherein said host device is operable to transmit said touch input over said network.

9. The system for remote network communication described in claim 8, wherein said client device is further operable to packetize said touch input.

10. The system for remote network communication described in claim 8, wherein said host device is further operable to packetize said rendered data.

11. The system for remote network communication described in claim 8, wherein said client device is further operable to receive said rendered data from said host device over said network.

12. The system for remote network communication described in claim 8, wherein said touch input is packetized using H.264 format.

13. The system for remote network communication described in claim 8, wherein said client device is operable to execute a respective application independent of any other client device from a plurality of client devices.

14. The system for remote network communication described in claim 8, wherein said host device is a virtual machine, wherein said virtual machine is operable to execute a respective application independent of any other virtual machine from a plurality of virtual machines.

15. A non-transitory computer readable medium for remote network communication, comprising:
capturing a touch input directly from an electronic visual display coupled to a client device;
transmitting said touch input from said client device to a host device over a network;
receiving a rendered display responsive to said touch input from said host device producing a rendered data; and
displaying said rendered data on said client device.

16. The computer readable medium described in claim 15, wherein said transmitting further comprises:
packetizing said touch input using said client device.

17. The computer readable medium described in claim 15, wherein said receiving a rendered display further comprises:
unpacketizing said rendered data.

18. The computer readable medium described in claim 15, wherein said displaying further comprises:
rendering said rendered data from said host device.

19. The computer readable medium described in claim 15, wherein said touch input is packetized using H.264 format.

20. The computer readable medium described in claim 15, wherein said client device is operable to execute a respective application independent of any other client device from a plurality of client devices.

21. The computer readable medium described in claim 15, wherein said host device is a virtual machine, wherein said virtual machine is operable to execute a respective application independent of any other virtual machine from a plurality of virtual machines.
